(19) United States
(12) Patent Application Publication
(10) Pub. No.: US 2005/0238951 A1
(43) Pub. Date: Oct. 27, 2005

(54) Secondary battery

(76) Inventors: Seok-Yoon Yoo, Suwon-si (KR); Ki-Ho Kim, Suwon-si (KR); Yong-Sam Kim, Suwon-si (KR)

Correspondence Address: Robert E. Bushnell, Suite 300, 1522 K Street, N. W., Washington, DC, 20005, US

(21) Appl. No.: 11/115,197

(22) Filed: Apr. 27, 2005

(30) Foreign Application Priority Data
Apr. 27, 2004 (KR) 10-2004-0028906

(51) Int. Cl. H01M 4/00

(52) U.S. Cl. 429/122; 429/163

(57) ABSTRACT

A secondary battery which has a case, an electrode assembly which is housed in the case and includes a positive electrode, a negative electrode, and a separator interposed between the positive electrode and the negative electrode, a cap assembly which is assembled with the case to close and seal the electrode assembly and to lead an electric current, and a positive current collecting plate and a negative current collecting plate that are electrically connected with the electrode assembly and that face each other. The negative electrode includes an uncoated region which is not coated with an active material at the end of the negative electrode, and the uncoated region is electrically connected with a negative current collecting plate whose surface is treated with a metal different from the metal of the negative electrode.

### CLAIM OF PRIORITY

This application claims priority to and the benefit of Korean Patent Application No. 10-2004-0028906 filed in the Korean Intellectual Property Office on Apr. 27, 2004, the entire content of which is incorporated herein by reference.

### FIELD OF THE INVENTION

The present invention relates to a secondary battery, and more particularly, to a secondary battery with improved welding characteristics.

### BACKGROUND OF THE INVENTION

According to usage and battery capacity, secondary batteries are classified into low-capacity secondary batteries, which are referred to as ‘small batteries’ hereinafter, that use a single battery cell packaged in the form of a pack, and high-capacity secondary batteries, which are referred to as ‘large batteries’ hereinafter, that use scores of battery cells packaged into a battery pack for driving a motor.

Small batteries are used as the power source for small electronic devices, such as mobile phones, laptop computers, and camcorders, while large batteries are used as the power source for driving motors in hybrid automobiles and the like.

Depending on the external shape, small batteries may be classified into different types, such as square and cylindrical batteries. A small battery generally includes a positive electrode, a negative electrode, and a separator that is interposed as an insulator between the positive electrode and the negative electrode, that are spiral-wound in a form of jelly roll to thereby form an electrode assembly. The electrode assembly is inserted into a container of a predetermined shape to form the battery.

The positive and negative electrodes have lead terminals, that is, conductive tabs that collect the current produced from the positive and negative electrodes of the battery. The conductive tabs are fixed onto the electrode assembly by welding to induce the current generated from the positive and negative electrodes to the positive and negative terminals of the battery.

When the structure of the small battery is directly applied to a large battery, the operation characteristics of the large battery are not fulfilled in respect of electric capacity and power output. Therefore, a multi-tab structure using a plurality of tabs between electrode assemblies and, further, a current collecting plate that replaces the tabs have been suggested.

However, since electrode current collectors and tabs are formed of thin films, they may be burned or torn due to heat and/or pressure generated during welding. Thus, there are problems in that their shapes are hardly maintained and that the welding is difficult.

In addition, a secondary battery including a current collecting plate also goes through a welding process to fix the current collector of the negative electrode to the negative current collecting plate, and the current collector of the negative electrode and the negative current collecting plate are generally formed of copper (Cu), which has a fine electrical conductivity. However, since the welding is difficult to perform between Cu, it is hard to fix the current collector of the negative electrode to the current collecting plate, and this leads to degradation in product quality. Furthermore, since Cu has a high thermal conductivity, there is a problem that it is burned out during welding, which causes an electric short between the positive electrode and the negative electrode.

### SUMMARY OF THE INVENTION

It is therefore an aspect of the present invention to resolve the problems described above.

It is also an aspect of the present invention to provide an improved secondary battery.

It is further an aspect of the present invention to provide a secondary battery with improved welding characteristics between an electrode assembly and a current collecting plate.

It is another aspect of the present invention to provide a secondary battery having an increased battery power output and an increased current collecting efficiency by firmly fixing an electrode assembly and a current collecting plate.

To achieve these aspects, the present invention provides a secondary battery constructed with a case; an electrode assembly housed in the case, the electrode assembly including a positive electrode, a negative electrode, and a separator interposed between the positive electrode and the negative electrode; a cap assembly assembled with the case to close and seal the electrode assembly and to lead an electric current; and a positive current collecting plate and a negative current collecting plate electrically connected with the electrode assembly, the positive current collecting plate and the negative current collecting plate facing each other, the electrode assembly positioned between the positive current collecting plate and the negative current collecting plate, at least a part of the surface of the negative current collecting plate being treated with a metal different from a metal of the negative electrode, the surface treated negative current collecting plate being electrically connected to the uncoated region of the negative electrode.

According to another embodiment, the negative electrode and the negative current collecting plate are formed of copper (Cu), and the surface of the negative current collecting plate is treated with nickel (Ni), tin (Sn), or zinc (Zn), and preferably nickel (Ni).

According to another embodiment, the negative current collecting plate is fixed onto the end of the uncoated region by laser welding.

According to another embodiment, the negative current collecting plate is formed in a plate shape, and includes a contact unit which is protruded to contact the end of the uncoated region.

According to another embodiment, the contact unit of the negative current collecting plate is formed with at least one groove having a predetermined pattern

According to another embodiment, the contact unit is formed in a radial shape on the negative current collecting plate.

According to yet an embodiment, A secondary battery may be constructed with a case has an opening; an electrode assembly housed in the case, the electrode assembly comprising a first electrode, a second electrode and a separator interposed between the first electrode and the second electrode, the second electrode comprising a second current collector and a second active material; a cap assembly closing the opening and sealing the electrode assembly to lead an electric current; and a first current collecting element and a second current collecting element electrically connected to the electrode assembly, the first current collecting element and the second current collecting element facing each other, the electrode assembly positioned between the first current collecting element and the second current collecting element, at least a part of the surface of the second current collecting element treated with a metal having a higher thermal conductivity than the second current collector of the second electrode, the surface-treated part fixed to the second current collector of the second electrode.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a cross-sectional view showing a secondary battery in accordance with an embodiment of the present invention;

FIG. 2 is a perspective view illustrating a negative current collecting plate in accordance with the embodiment of the present invention;

FIG. 3 is a cross-sectional view describing a contact between a negative electrode and a negative current collecting plate; and

FIG. 4 is a perspective view illustrating a negative current collecting plate in accordance with another embodiment of the present invention.

### DETAILED DESCRIPTION OF THE EMBODIMENTS

In the following detailed description, the following embodiments of the invention have been shown and described, simply by way of illustration of the best mode contemplated by the inventors of carrying out the invention. As will be realized, the invention is capable of modification in various respects, all without departing from the invention. Accordingly, the drawings and description are to be regarded as illustrative in nature, and not restrictive.

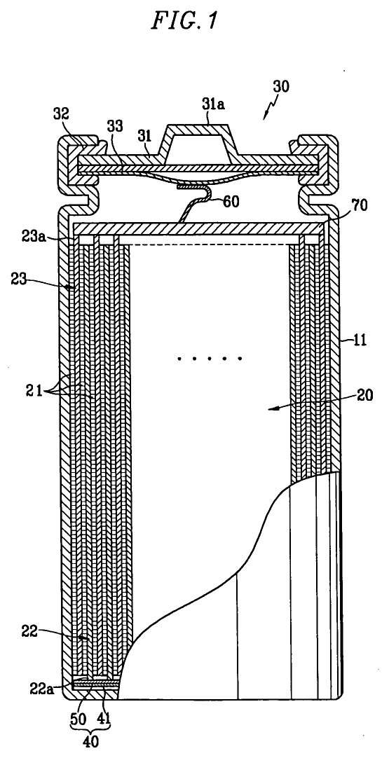

FIG. 1 is a cross-sectional view showing a secondary battery 10 in accordance with an embodiment of the present invention. The secondary battery of the present invention will be described hereafter with reference to the drawing.

The secondary battery 10 of the present embodiment is fabricated by inserting an electrode assembly 20, which includes a positive electrode 23, a negative electrode 22, and a separator 21 positioned as an insulator between the positive electrode 23 and the negative electrode 22, into a cylindrical or hexahedral case 11, which has an opening, and then closing and sealing the opening of the case 11 with a cap assembly 30.

The case 11 is formed of a conductive material such as Al, an Al alloy, and steel plated with Ni. As aforementioned above, it is preferable that the case 11 has a cylindrical or hexahedral shape with an internal space for housing the electrode assembly 20, but the present invention is not limited to these shapes.

The electrode assembly 20 has a layered structure such that the separator 21 is placed between the positive electrode 23 and the negative electrode 22, which are formed by coating the current collectors with corresponding active materials, and the electrode assembly 20 of the layered structure can be wound into a jelly-roll structure. The drawing presents the case 11 in a cylindrical form and the electrode assembly 20 in the jelly-roll structure.

Herein, the positive electrode 23 of the electrode assembly 20 includes an uncoated region 23a, which is not coated with a positive active material, in the brim of the current collector thereon, and the positive electrode 23 is electrically connected with a positive current collecting element which has preferably a plate shape (i.e., a positive current collecting plate 70). The positive current collecting plate 70 is connected with the cap assembly 30 through a tab 60. Preferably, the positive current collecting plate 70 is formed of Al.

Similarly, an uncoated region 22a, which is not coated with a negative active material, is provided to the current collector of the negative electrode 22 in the lower part of the negative electrode 22 of the electrode assembly 20. Herein, as illustrated in FIG. 1, a negative current collecting element which has preferably has a plate shape (i.e., a negative current collecting plate 40) is interposed between the negative electrode 22 and the case 11 to electrically connect the uncoated region 22a of the negative electrode 22 with the case 11.

The negative current collecting plate 40 provides a path for an electric current to flow along, and it is related to a current collecting efficiency of a cell. Preferably, the negative current collecting plate 40 is fabricated in a form of a plate to provide operation characteristics of a large battery. Further description of it will be provided later.

Subsequently, the cap assembly 30 is connected with the case 11 and seals the case 11. It includes a cap plate 31 having an external terminal 31a and a gasket 32 for insulating the cap plate 31 from the case 11. The cap assembly 30 has a space for buffering internal pressure and it can further include a vent plate 33 having a safety relief valve which is broken at a predetermined pressure level to release gas upon a high pressure condition, thereby preventing the explosion of the battery.

The formation of the safety relief valve is not limited to the vent plate 33 but the safety relief valve can be formed in any structure as long as it can electrically cut off the electrode assembly 20 and the external terminal 31a through the tab 60 upon a pre-established pressure level.

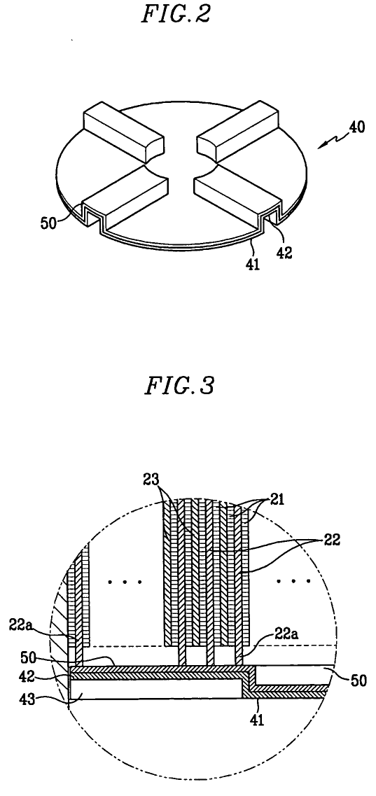

Hereinafter, the negative current collecting plate 40 suggested in the present invention will be described with reference to FIG. 2.

The negative current collecting plate 40 has a disk-shaped body 41 and the body 41 includes at least one contact unit 42 protruded toward the electrode assembly 20 to electrically contact the uncoated region 22a of the negative electrode 22.

Herein, the body 41 is not limited to the disk shape but it can be realized in diverse shapes, such as a triangle, a square, and a polygon. The contact unit 42 can be formed by performing a beading process on the body 41. A plurality of contact units 42 are formed and positioned in a radial form on the body 41. For example, as illustrated in the drawing, four contact units are provided and positioned on the body 41 in a cross shape.

In the present embodiment, the contact units 42 are formed in a straight line from the edge of the body 41 to the center of the body 41. However, they can be formed in the form of a convex embossment with a regular space and they can be formed in other diverse shapes. For example, the cross section of the contact units 42 can be a square, triangle, or a hemisphere.

In the process of fabricating the secondary battery, when the electrode assembly 20 is formed, the contact units 42 of the negative current collecting plate 40 contact the uncoated regions 22a of the negative electrode 22 and they are connected electrically (see FIG. 3). Commonly, the connection is carried out through welding. That is, the negative current collecting plate 40 is fixed to the uncoated regions 22a by contacting the uncoated regions 22a with the contact units 42 and performing a laser welding along the groove 43 of the contact units 42.

However, the negative current collecting plate 40 and the negative electrode 22 are formed of Cu, which is a material having a higher electrical conductivity than the positive electrode, in order to generate an electromotive force between the electrodes. As mentioned above, there is a problem that it is very hard to weld Cu due its properties. That is, since Cu has a high thermal conductivity, heat is not converged into a weld point but it is spread along the surface.

To solve the problem, the negative current collecting plate 40 of the present invention includes a surface treatment layer 50 to help welding with the negative electrode 22. Preferably, the surface treatment layer 50 is formed of Ni. If the negative current collecting plate 40 is formed of Ni, there is a problem that a desired level of an electromotive force is hardly achieved because Ni has a lower electrical conductivity than Cu. Therefore, in the present invention, the surface of the negative current collecting plate 40 is treated with Ni to perform the welding easily while maintaining the electric conductivity of Cu.

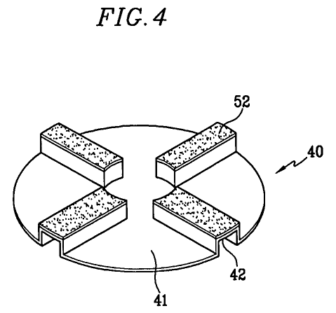

Herein, the entire surface of the negative current collecting plate 40 can be treated with Ni or, the surface treatment can be performed only on the contact units 42 that contact the negative electrode 22. Referring to FIG. 4, only contact units 42 of the body 41 have the surface-treatment layer 52.

Also, it is possible to form the surface treatment layer 50 on the whole surface of the negative current collecting plate 40. The surface treatment layer has a thickness ranging from 1 micrometer to 50 micrometers. When the thickness is less than 1 micrometer, a surface-treatment effect is not sufficient. Whereas, when it is more than 50 micrometers, conductivity of the negative current collecting plate is deteriorated.

It is preferable that the surface of the negative current collecting plate 40 is surface-treated using a coating method or a clad method. The coating method includes electrolytic plating and electroless plating. Since Ni has a high corrosion-resistance, it can prevent the negative current collecting plate 40 from being oxidized in an electrolyte.

Although the present invention is described with an example of Ni as a coating material in the above, the present invention is not limited to it, and any other metal except copper (Cu) can be used.

The secondary battery of the present invention is useful as the power source for high power electric devices such as electric vehicles, hybrid electric vehicles, wireless vacuum cleaners, motorbikes, and motor scooters.

While the present invention has been described with respect to certain embodiments, it will be apparent to those skilled in the art that various changes and modifications may be made without departing from the scope of the invention as defined in the following claims.

The technology of the present invention can solve the aforementioned problems and provide the operation characteristics required by a large battery. Furthermore, since it can firmly fix the negative current collecting plate with the electrode assembly, it can solve the problems caused by the weak connection between the negative current collecting plate and the electrode assembly and enable charge and discharge to be performed stably within a short time.

1. A secondary battery comprising:
a case;
an electrode assembly housed in the case, the electrode assembly comprising a positive electrode, a negative electrode having an uncoated region which is not coated with a negative active material at an end of the negative electrode, and a separator interposed between the positive electrode and the negative electrode;
a cap assembly assembled with the case to close and seal the electrode assembly and to lead an electric current; and
a positive current collecting plate and a negative current collecting plate that are electrically connected with the electrode assembly, the positive current collecting plate and the negative current collecting plate facing each other, the electrode assembly positioned between the positive current collecting plate and the negative current collecting plate, at least a part of the surface of the negative current collecting plate being treated with a metal different from a metal of the negative electrode, the surface treated negative current collecting plate being electrically connected to the uncoated region of the negative electrode.

2. The secondary battery of claim 1, wherein the surface-treated part of the negative current collecting plate is fixed onto the uncoated region of the negative electrode by laser welding.

3. The secondary battery of claim 1, wherein the negative current collecting plate comprises a contact unit protruded to contact the uncoated region of the negative electrode.

4. The secondary battery of claim 3, wherein the contact unit has at least one groove.

5. The secondary battery of claim 4, wherein the contact unit is in a radial shape on the negative current collecting plate.

6. The secondary battery of claim 3, wherein the surface-treated part of the negative current collecting plate is the contact unit.

7. The secondary battery of claim 1, wherein the secondary battery is a cylindrical secondary battery.

8. The secondary battery of claim 1, wherein the negative electrode comprises copper.

9. The secondary battery of claim 8, wherein said at least the part of the surface of the negative current collecting plate is treated with Ni.

10. The secondary battery of claim 1, wherein the secondary battery is used for a motor driven device.

11. A secondary battery comprising:
a case;
an electrode assembly housed in the case, the electrode assembly comprising a first electrode, a second electrode, and a separator interposed between the first electrode and the second electrode, the second electrode comprising an active material and a current collector made of copper coated with the active material, the second electrode having an uncoated region of the current collector at an end of the second electrode;
a cap assembly assembled with the case to close and seal the electrode assembly and to lead an electric current; and
a first current collecting plate and a second current collecting plate that are electrically connected with the electrode assembly, the first current collecting plate and the second current collecting plate facing each other, the electrode assembly positioned between the first current collecting plate and the second current collecting plate, at least a part of the surface of the second current collecting plate being treated with a metal different from copper, the surface-treated part of the second current collecting plate being electrically connected to the uncoated region of the second electrode.

12. A secondary battery, comprising
a case has an opening;
an electrode assembly housed in the case, the electrode assembly comprising a first electrode, a second electrode and a separator interposed between the first electrode and the second electrode, the second electrode comprising a second current collector and a second active material;
a cap assembly closing the opening and sealing the electrode assembly to lead an electric current; and
a first current collecting element and a second current collecting element electrically connected to the electrode assembly, the first current collecting element and the second current collecting element facing each other, the electrode assembly positioned between the first current collecting element and the second current collecting element, at least a part of the surface of the second current collecting element treated with a metal having a higher thermal conductivity than the second current collector of the second electrode, the surface-treated part fixed to the second current collector of the second electrode.

13. The secondary battery of claim 12, wherein the first and second current collecting elements are formed in a plate shape.

14. The secondary battery of claim 12, wherein the second current collector of the second electrode has an uncoated region which is not coated with the second active material, the uncoated region connected to the surface-treated part of the second current collecting element by laser welding.

15. The secondary battery of claim 12, wherein the second current collecting element comprises a contact unit protruded to contact the current collector of the second electrode.

16. The secondary battery of claim 15, wherein the contact unit has at least one groove.

17. The secondary battery of claim 16, wherein the contact unit is in a radial shape on the second current collecting element.

18. The secondary battery of claim 15, wherein said at least a part of the surface of the second current collecting plate is the contact unit.

19. The secondary battery of claim 12, wherein the secondary battery is a cylindrical secondary battery.

20. The secondary battery of claim 12, wherein the second current collector of the second electrode comprises and the second current collecting element are made of Cu.

21. The secondary battery of claim 20, wherein said part of the surface of the second current collecting element is treated with Ni.
